(19) United States
(12) Patent Application Publication
(10) Pub. No.: US 2005/0075001 A1
(43) Pub. Date: Apr. 7, 2005

(54) Extender device for accessing a connector

(76) Inventors: Simon E. Shearman, Ontario (CA); Harley Summach, Ontario (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/679,748

(22) Filed: Oct. 6, 2003

(51) Int. Cl. H01R 13/627

(52) U.S. Cl. 439/352

(57) ABSTRACT

An extender device including a base and an arm, the arm pivotally attached to the base to depress a latch on a connector. The extender device may also include a light pipe. Multiple extender devices may be grouped to form modules.

### TECHNICAL FIELD

This invention relates to connectors, and more particularly to devices to provide ease of access to connectors.

### BACKGROUND

In many applications, signals are carried from one location to another on fibers and the fibers include connectors on an end that plugs into a receptacle. The connector may plug into a variety of receptacles including a faceplate on a wall or rack mount. For example, in a telephone the connector plugs into a phone jack in a wall mounted configuration. In another case, for optical communication a set of dual LC connectors plug into a rack mounted optical receiver. While the applications may vary, ends typically include a connector having a latch. Removal of the end from the receptacle generally involves depressing the latch on the connector and pulling the end away from the receptacle.

### SUMMARY

In one aspect, the invention features an extender device having a base and an arm. The arm being pivotally attached to the base to depress a latch on a connector.

One or more of the following features may also be included. The base may include a pivot post and the arm may include a pivot hole such that the pivot post connects to the pivot hole. Pegs may be affixed to the base such that the pegs control a bend radius of said end. The pegs can be configured to provide a bend radius greater than 20 degrees or a bend radius of 90 degrees. An expansion limiting member may be included and configured to limit the expansion between the base and arm. The base may include an extension region to support a boot portion of an end. The expansion region may be configured such that when the end is inserted into the device, the end would extend past the extension region. The base may include a backstop to limit movement of the end. The base may include a pivot post. The pivot post may be a cylindrical shape. The base may include a connector guide slot and connector housing to hold the end. The arm may include an arm tab and the base may include a base tab such that urging the arm tab and base tab together causes the arm to pivot on the base. The arm may include a pivot hole to attach the arm to the base. The arm may be plastic and the plastic may be transparent. The arm may be sheet metal or die case metal.

In another aspect of the invention, a device includes an extender device to depress a latch, and a light pipe.

One or more of the following features may be included. The light pipe may include a conical region. The light pipe may include a refractive inner layer. The light pipe may include a bend such that light is refracted around the bend.

In another aspect of the invention, an extender module may include a plurality of extender devices wherein each extender device includes a base and an arm and the arm is configured to pivot on the base to release a latch on a connector.

One or more of the following features may also be included. The extender module may include guide tracks and slots on the base of the extender device. The plurality of extender devices may include four extender devices.

In another aspect of the invention a method for removing a connector includes providing an extender device removably coupled to a connector, and applying a force between an arm and a base of said extender device such that a latch on the connector is depressed.

These general and specific aspects may be implemented using a system or a method, or any combination of systems and methods.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a side view of an extender device and faceplate.

FIG. 2 shows components of the extender device.

FIG. 3 shows a top view of the extender device and a connector.

FIG. 4 shows a bottom view of the extender device and a connector.

FIG. 5 shows a module of extender devices.

FIGS. 6A and 6B shows a grouping of modules.

### DETAILED DESCRIPTION

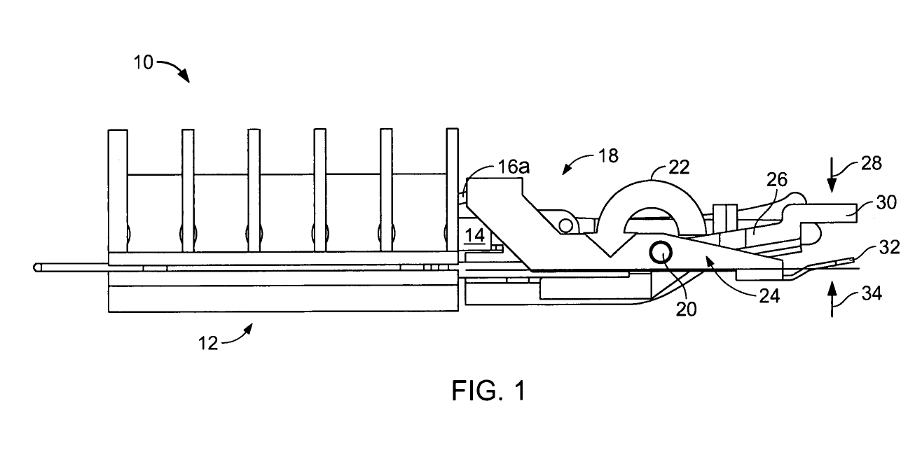

Referring to FIG. 1, an arrangement 10 includes a faceplate 12, a connector 14, and an extender 18. When connector 14 is plugged into faceplate 12, a latch 16a, typically, a spring-type latch on connector 14 prevents the end from dislodging from a receptacle (not shown) in the faceplate 12. Latch 16a holds the end in place by spring type action of the latch, and removal of the end includes depressing latch 16a. The end, including connector 14, removably attaches to extender 18. The extender 18 includes an arm 24 and a base 26. Arm 24 pivots on base 26 and engages latch 16a to allow latch 16a to be depressed and permitting connector 14 to be removed by the extender 18.

Extender 18 uses a “scissor” type mechanism provided by arm 24 pivotally attached via a pivot 20 to the base 26. Bringing arm 24 and base 26 together at one end of the extender causes opposite ends of the arm to contact the latch 16a and free the latch 16a from the faceplate 12. Thus, a user may apply a force to one end of extender device 18 which will release latch 16 at the other end of extender 18. As shown in FIG. 1, to remove the end, a user applies a downward force (denoted by arrow 28) on a base tab 30 of base 26 and an upward force (denoted by arrow 34) on an arm tab 32 of arm 24. Connector 14 limits the upward motion of base 26, thus, when forces 28 and 34 are applied the arm rotates on the pivot 20 (indicated by an arrow 22). Arrow 22 shows that when the base tab 30 and arm tab 32 are pushed together the arm rotates resulting in a downward force on latch 16a.

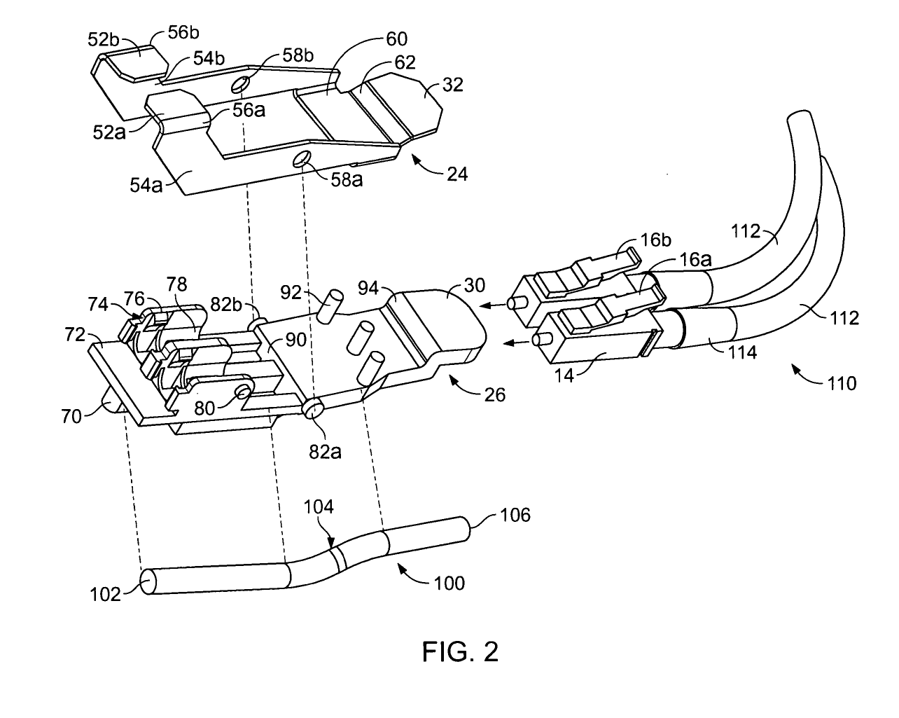

Referring to FIG. 2, components of the extender device 18 and an end 110 are shown. Arm 24 includes a first finger 52a supported on a first side member 54a of arm 24. The finger 52a on side 54a extends towards another finger 52b on an opposing side 54b of arm 24 which together allow the arm to engage and depress a pair of latches 16 on a pair of ends 110. Side 54a and side 54b each have a hole 58a and 58b. Pivot posts 82a and 82b on base 26 snap into pivot holes 58a and 58b to attach arm 24 to base 26. Thus, arm 24 attaches to base 26 using a post and hole configuration. Pivot post 82 snaps into pivot hole 58 such that arm 24 can pivot on base 26. The end 110 removably attaches to the base 26 allowing fingers 52a and 52b on arm 24 to depress connector latches 16. Alternately, base 26 may attach to arm 24 using a pin to provide the pivot point and the arm and base having holes to connect to the pin.

The base 26, in addition to the posts 82a and 82b, includes a set of guides and slots to hold end 110 in the appropriate location. Base 26 includes a connector guide slot 78 with connector housing 78 on either side of the slot. The connector 14 of an end 110 fits into connector guide slot 78 such that a portion of connector 14 extends past an extension region 72 of the base 26. This allows the end 110 to be plugged into a typical receptacle in faceplate 12 without modification of end 110 or the faceplate 12 (FIG. 1). A backstop 90 prevents end 110 from being pulled out of base 26. Connector housing 76 may also include a recess 74 to allow the extender device 18 to fit into limited space in the faceplate. This recess limits the height of the base to the same height as the connector.

Base 26 also includes features to limit the bend radius of a cord 112 and boot 114 on end 110. Pegs 92, attached to the base, prevent the cord from bending past a predetermined bend radius. Typical bend radius limitations are between 30 and 90 degrees. The configuration of the pegs 92 allows cord 112 to be dressed to bend left or right. The base may also include an expansion limit tab 80. Expansion limit tab 80 limits the expansion between arm 24 and base 26. When arm 24 and base 26 are expanded the side 54 of arm 24 hits the expansion limit tab 80 stopping the expansion between arm 24 and base 26.

In one example, arm 24 and base 26 are molded from plastic producing a unitary piece having the features discussed above. The plastic may be translucent or transparent allowing a user to view the connector and faceplate through extender 18. Arm 24 and/or base 26 could instead be composed of multiple parts adhesively bonded to form the structure. In another example, the arm and base could be composed of metal or another firm material.

The exact shape of the arm 24 and base 26 can vary. In one example, as shown in FIG. 2, the base tab 30 and arm tab 32 are attached to the base 26 and arm 24 in an angled configuration. Base tab 30 may be connected to the body of the base by an angled region 94. Thus, base tab 26 is situated above the body of the base due to angled region 94. Much like base tab 30, arm tab 32 attaches to a support region 60 by an angled region 62. The support region 60 connects sides 54a and 54b, and arm tab 32 is angled upward from support region 60. The positioning of the fingers 52a and 52b relative to sides 54a and 54b can include an angled connection regions 56a and 56b or the fingers may be simply attached to the side in another approximately perpendicular fashion. The fingers may also be connected forming a single bar between the sides 54a and 54b, the bar depressing the latches of a connector (not shown). In some applications, faceplate 12 may include an indicator light to indicate if the port is in use. A light pipe 100, as shown may be attached to a bottom portion of the base 26 to allow a user to view the light at the end of the extender device. In this example, base 26 would include a light pipe support 70. Light pipe 100 includes an entry point 102 to be placed near the indicator light and an exit point 106 where the light will exit. In some situations, it may be advantageous for the light pipe to have a bend 104. In this case, a reflective coating on the inside surface of light pipe 100 refracts the light and guides the light from entry point 104 to exit point 102. While the light pipe shown is cylindrical, the light pipe could be a variety of shapes including a conical shape to allow greater collection of light from the indicator light.

One example where extender 18 is used in conjunction with light pipe 100 is for optical communication. Optical communication relies on “dual LC” type connectors (as described in IEEE specification 1394B). The connectors are paired having jacketed fiber cords 112 to carry the light. Due to the presence of connectors in pairs, the extender depicted in FIGS. 1 and 2 is configured to have dual connector guide slots 78 and dual fingers 52. Thus, the dual LC connector snaps into a single extender device. In such optical applications, an LED located on the port or housing shows the state of the device. In other arrangements, a single connector with a single conductor is inserted into the faceplate and thus, the extender depicted in FIGS. 1 and 2 could be configured to have the dual finger arranged to engage the latch on a single connector, or could dispense with one of the fingers and one of the arms and merely use a single finger to engage the latch.

When multiple lines are included on a single housing, a user can have difficulty accurately reading an individual line. The light pipe 100 is attached to the extender 18 to allow a user to accurately read the LED status indicator. The light pipe will collect the light from the LED on the dual LC port and channel the light to an exit point visible to an operator. For a dual LC connector it is very important to limit the bend radius of the fiber cord 112 and to ensure the fiber cord does not pull out of the boot 114. To ensure the fiber cord does not bend past the minimum bend radius the pegs 92 are placed to provide a predetermined bend radius.

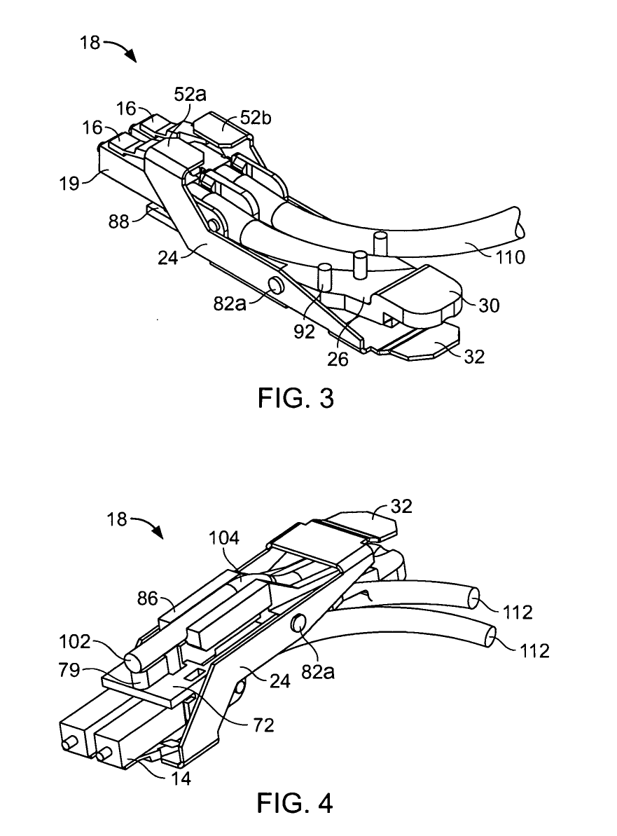

Referring to FIG. 3, end 110 is attached to the extender 18. The connector 14 of end 110 fits into the connector guide slot 78 between the connector housing 76. Connector 14 of end 110 extends past the end of extension region 72 on extender 18. The fingers 52 of arm 24 are above the connector latch 16. Application of a force between arm tab 32 and base tab 30 will cause the fingers 52 to depress the connector latch 16. End 110 can be removed using extender 18. Pegs 82 limit the bend radius of cord 112.

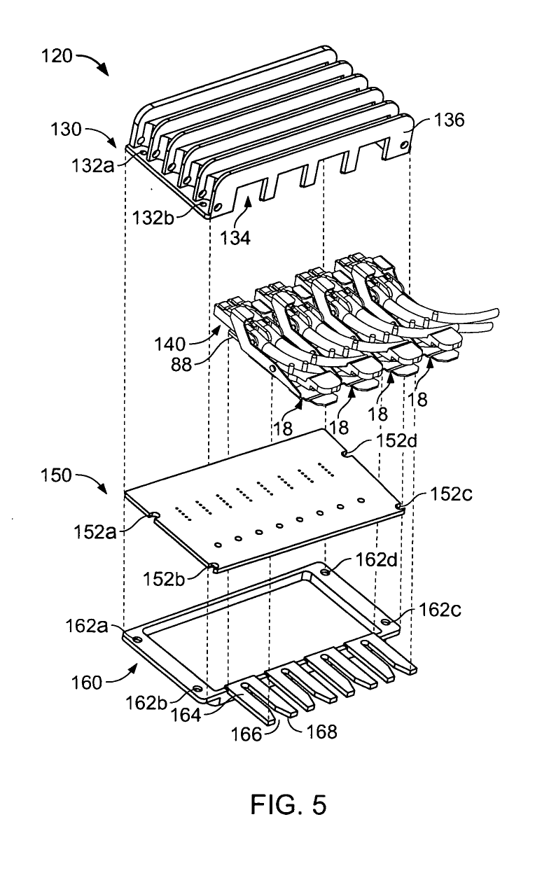

Referring to FIG. 4 the connector 14 of end 110 extends past the end of extension region 70 on extender 18. A light pipe 100 is attached to the base between two guide rails 86. The light pipe includes an entry point 102 to collect light from an indicator light on the faceplate 12.

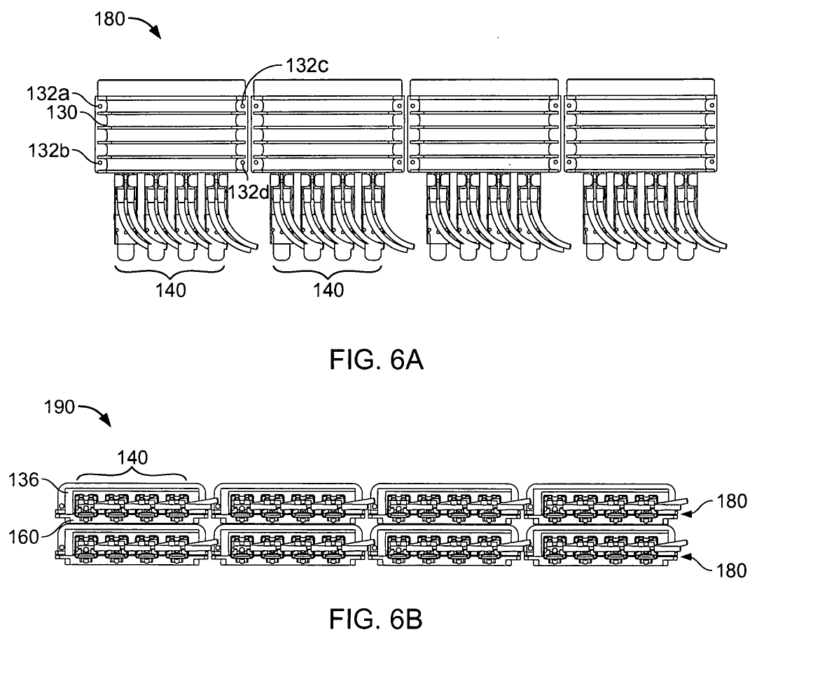

Referring to FIG. 5, connectors may be grouped to form packs 140. A pack typically includes a set of 4 extenders. Ends 110 snap into each extender 18 and plug into a housing 130 on faceplate 12 (FIG. 1). While modules provide the convenience of grouping sets of ends, the limited space may make it harder to plug a single connector into a receiver. Thus, each extender 18 in pack 140 includes a guide rail 88 that fits into a slot 166 on a guide track 160. The guide track 160 attaches to the baseboard 150, and baseboard 150 attaches to the housing 130. Screws thread through a housing screw hole 130a-d, baseboard screw hole 152a-d, and guide track screw hole 160a-d attaching guide track 160, baseboard 150 and housing 130. Housing 130 includes slots 134 for the connectors. Thus, the guide track 160 is positioned by the screws to direct the placement of module 140 such that the connectors are guided into the slots 134 in the housing 130. The guide track includes fingers 164 to form guide slot 166. The set of fingers may include an angled end portion 168 to guide the guide rail 88 on the extender into the slot 166.

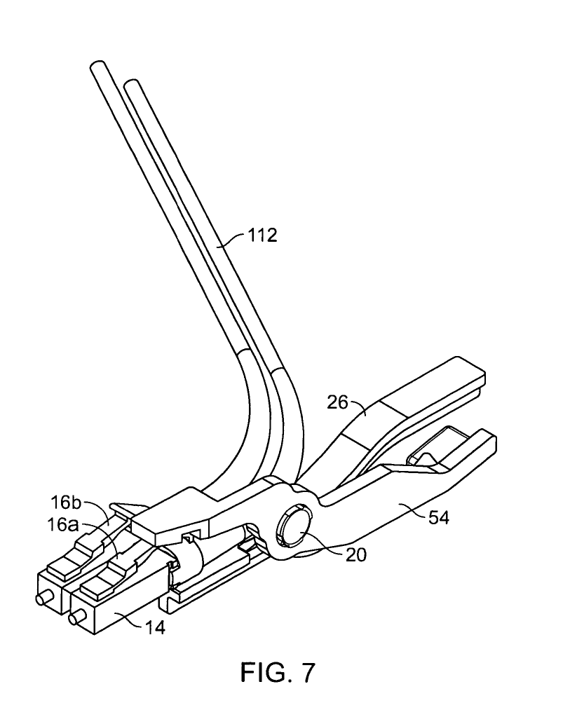

Referring to FIG. 6, sets of modules 140 may be grouped into larger units by attaching multiple housing units 130 into rows 180. Multiple rows 180 are stacked form a system 190. The use of extenders 18 facilitates this process by controlling the bend radius of each end and allowing easier access to plug (via guide track) and unplug (via extender device) each end.

A number of embodiments of the invention have been described. Nevertheless, it will be understood that various modifications may be made without departing from the spirit and scope of the invention. For example, the arm of the extender device is split down the middle such the arm contains two sides each attached to a pivot on the base such that a single latch may be depressed. In another example, the extender device may include a single pivot point 20 and an arm having a single side 54 as shown in FIG. 7. Accordingly, other embodiments are within the scope of the following claims.

1. An extender device comprising
a base and
an arm, the arm pivotally attached to the base to depress a latch on a connector.

2. The device of claim 1, wherein the base includes a pivot post and the arm includes a pivot hole such that the pivot post connects to the pivot hole.

3. The device of claim 1, further comprising
pegs affixed to the base wherein the pegs control a bend radius of a fiber.

4. The device of claim 3, wherein the pegs are configured to provide a bend radius greater than 20 degrees.

5. The device of claim 3, wherein the pegs are configured to provide a bend radius of 90 degrees.

6. The device of claim 3, further comprising:
an expansion limiting member configured to limit the expansion between the base and arm.

7. The device of claim 3, wherein the base includes an extension region to support a connector.

8. The device of claim 7, wherein the expansion region is configured such that when the connector is inserted into the device, the connector would extend past the extension region.

9. The device of claim 1, wherein the base includes a backstop to limit movement of the connector.

10. The device of claim 1, wherein the base includes a pivot post.

11. The device of claim 11, wherein the pivot post includes a cylindrical shape.

12. The device of claim 1, wherein the base includes a connector guide slot and connector housing to hold the connector.

13. The device of claim 1, wherein the arm includes an arm tab and the base includes a base tab such that urging the arm tab and base tab together causes the arm to pivot on the base.

14. The device of claim 1, wherein the arm includes a pivot hole to attach the arm to the base.

15. The device of claim 1, wherein the arm is plastic.

16. The device of claim 1, wherein the plastic is transparent.

17. The device of claim 1, wherein the arm is sheet metal.

18. The device of claim 1, wherein the arm and base are die cast metal.

19. A device comprising an extender device to depress a latch, and a light pipe.

20. The extender device of claim 18, wherein said light pipe includes a conical base region.

21. The extender device of claim 18, wherein said light pipe includes a refractive inner layer.

22. The extender device of claim 18, wherein the light pipe includes a bend and light is refracted around the bend.

23. An extender module comprising
a plurality of extender devices wherein each extender device includes a base and
an arm and the arm is configured to pivot on the base to release a latch on a connector.

24. The extender module of claim 23 further comprising
guide tracks and
slots on the base of the extender device.

25. The extender module of claim 23 wherein the plurality of extender devices includes four extender devices.

26. A method for removing a connector, the method comprising
providing an extender device removably coupled to a connector, and
applying a force between an arm and a base of said extender device such that a latch on the connector is depressed.
